(19) United States
(12) Patent Application Publication
(10) Pub. No.: US 2017/0258021 A1
(43) Pub. Date: Sep. 14, 2017

(54) HYDROPONIC DEVICE

(71) Applicant: Quanta Computer Inc., Tao Yuan Shien (TW)

(72) Inventors: Chia-Hsiang Chiu, Taoyuan City (TW); Chien-Ming Sung, Taoyuan City (TW); Wei-Cheng Huang, Taoyuan City (TW); Chun-Wei Liu, Taoyuan City (TW); Pei-Te Liu, Taoyuan City (TW); Hung-Hsuan Su, Taoyuan City (TW); Chi-Fang Ho, Taoyuan City (TW); Hsien-Yao Shui, Taoyuan City (TW); Kun-Lin Wu, Taoyuan City (TW); Po-Hsien Huang, Taoyuan City (TW); Chen-Ying Wang, Taoyuan City (TW); Cheng-Han Huang, Taoyuan City (TW); Kun-Lung Wu, Taoyuan City (TW); Tsung-Yu Wu, Taoyuan City (TW); Tse-An Lin, Taoyuan City (TW); Chien-Fa Huang, Taoyuan City (TW); Mao-Sung Lin, Taoyuan City (TW)

(21) Appl. No.: 15/181,701

(22) Filed: Jun. 14, 2016

(30) Foreign Application Priority Data
Mar. 10, 2016 (TW) 105107309

(51) Int. Cl. A01G 31/02; A01G 9/24; H04W 88/04; F21K 99/00; F21V 23/00; H05B 37/02; A01G 7/04; A01G 9/26

(52) U.S. Cl. CPC A01G 31/02; A01G 7/045; A01G 9/247; A01G 9/246; A01G 9/26; F21K 9/30; F21V 23/003; H05B 37/0272; H04W 88/04; F21W 2131/308

(57) ABSTRACT

A hydroponic device includes a water tank, a drain pan, a hydroponic module and a light emitting diode module. The water tank delivers water to the drain pan via a drain pump. The water is then dispensed to each pot body of the hydroponic module. Each pot body includes an inner pot and an outer pot. Water inside the inner pot will flow to the outer pot through the draining hole. Water will flow out of an overflow outlet and re-enter the water tank if the water level is higher than the overflow outlet. The light emitting diode module is disposed above the hydroponic module.

### CROSS-REFERENCE TO RELATED APPLICATION

This application claims priority from Taiwan Patent Application No. 105107309, filed on Mar. 10, 2016, in the Taiwan Intellectual Property Office, the content of which is hereby incorporated by reference in its entirety for all purposes.

### BACKGROUND OF THE INVENTION

1. Field of the Invention

The present invention relates to a device for growing plants; more specifically, the present invention relates to a hydroponic device capable of culturing creatures in the water tank, and pumping water from the water tank to the pot bodies growing hydroponic plants, as well as converting the ammonia in water into nitrates for plants via the Nitrosomonas and Nitrobacter in the pot body, such that the purified water can be recycled for culturing the aquatic life.

2. Description of the Related Art

Usually aquatic life such as fish is cultured in the aquarium. However the excrements from the fish will release high amount of ammonia-nitrogen mixture, which might poison the fish inside the aquarium, so the water inside the aquarium has to be replaced frequently. Nevertheless, pollution might occur if the untreated water containing excrements from fish is discharged at will.

On the other hand, hydroponics is a method of growing plants without soil. Instead of using soil, the roots of the plants are suspended in water containing the nutrient solution by the support structure. However, the chemicals and salts of the nutrient solution tend to accumulate in the water, the excessive chemicals and salts is detrimental to the growth of the hydroponic plants, so the water used in the hydroponics has to be replaced on regular basis.

### SUMMARY OF THE INVENTION

In light of the aforementioned technical issues, the objective of the present invention is to provide a hydroponic device capable of solving the problem identified in the related art.

In accordance with the objective of the present invention, a hydroponic device is provided. The hydroponic device includes a water tank, a drain pan, at least one hydroponic module and at least one light emitting diode (LED) module. The water tank is disposed with a water pump. The drain pan is disposed above the water tank and disposed with a water outlet and a plurality of water dispensing openings. One end of a pipe is connected to the water outlet while the other end is connected to the water pump. The hydroponic module is disposed between the water tank and the drain pan, and includes a plurality of pot bodies. Each of the pot bodies respectively corresponds to each of the water dispensing openings and includes an inner pot and an outer pot. The inner pot having a plurality of draining holes on a bottom thereof is disposed in the outer pot. The outer pot is disposed with an overflow outlet near an opening of the outer pot. A draining channel connected to the overflow outlet is disposed on an outer side of the outer pot. The LED module is disposed above the at least one hydroponic module.

Preferably, when there are a plurality of hydroponic modules, the plurality of hydroponic modules overlap with each other, the uppermost hydroponic module is connected to the drain pan while the lowermost hydroponic module is connected to the water tank.

Preferably, the plurality of pot bodies of each hydroponic module and the plurality of pot bodies of an adjacent hydroponic module are arranged in staggered manner.

Preferably, two coupling parts are disposed at the bottom of each pot body; the pot body is coupled to a rim of the inner pot and a rim of the outer pot of a lower pot body via the two coupling parts.

Preferably, a connecting part is respectively disposed at both sides near an opening of each pot body; each pot body is interconnected with the pot bodies at both sides thereof via both of the connecting parts.

Preferably, the present invention further includes a controller disposed on the hydroponic device, wherein the controller transmits a control signal to the water pump and the at least one LED module.

Preferably, the water tank includes a cooler and the controller is connected to a water temperature sensor, the controller generates the control signal for the cooler according to water temperature information sensed by the water temperature sensor.

Preferably, the controller is connected to a room temperature sensor and receives room temperature information sensed by the room temperature sensor.

Preferably, the controller is connected to an ambient light sensor, the controller generates the control signal for the at least one light emitting diode according to brightness information sensed by the ambient light sensor.

Preferably, the controller includes a wireless telecommunication unit serving as connection between a remote device and the controller; the remote device transmits an instruction signal to the controller and the controller generates the control signal according to the instruction signal.

In conclusion, the hydroponic device of the present invention is able to pump the water with excrements of aquatic life to each pot body, and then the nitrifying bacteria such as the Nitrosomonas and Nitrobacter in the pot body purify the water by converting the ammonia into nitrates, such that the present invention is capable of purifying water for the aquatic life as well as supplying nutrients for the hydroponic plants. Besides, the LED module of the present invention is able to enhance the growth rate of the hydroponic plants by supplying the hydroponic plants with light for photosynthesis.

### BRIEF DESCRIPTION OF THE DRAWINGS

FIG. 1 is the schematic diagram illustrating the hydroponic device of the present invention.

FIG. 2 is the schematic diagram illustrating the inner pot of the hydroponic device of the present invention.

FIG. 3 is the schematic diagram illustrating the outer pot of the hydroponic device of the present invention.

FIG. 4 is the schematic diagram illustrating part of the hydroponic module of the hydroponic device of the present invention.

FIG. 5 is the block diagram illustrating the hydroponic device of the present invention.

### DESCRIPTION OF THE PREFERRED EMBODIMENTS

The present invention has been described with some preferred embodiments thereof and it is understood that many changes and modifications in the described embodiments can be carried out without departing from the scope and the spirit of the invention that is intended to be limited only by the appended claims.

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

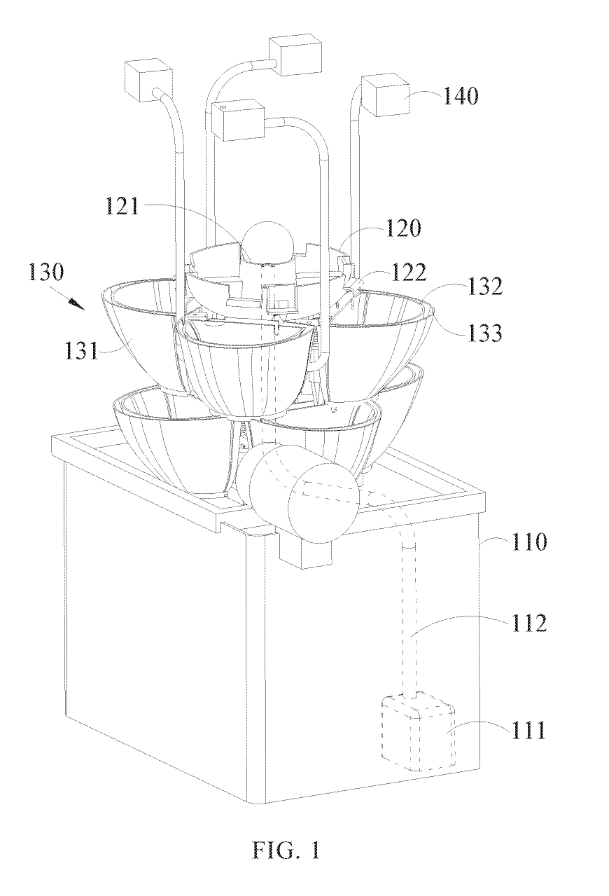

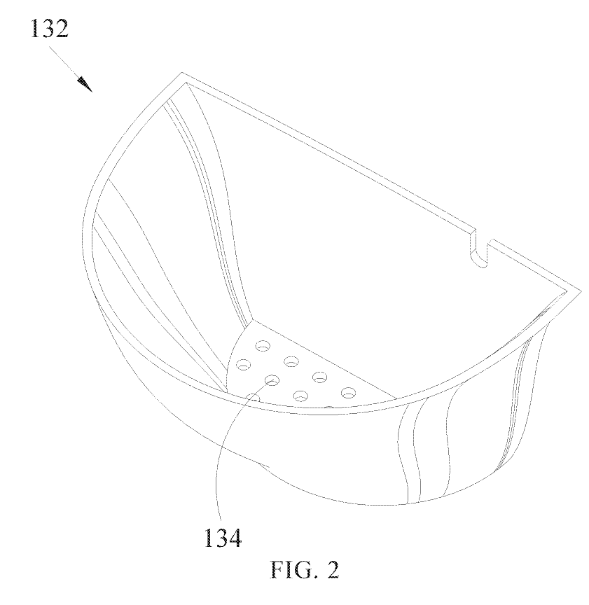

Refer to FIGS. 1 to 3, which are the schematic diagrams respectively illustrating the hydroponic device, the inner pot and the outer pot of the hydroponic device according to the present invention. As can be appreciated in the figures, the hydroponic device 100 of the present invention may include a water tank 110, a drain pan 120, at least one hydroponic module 130 and at least one light emitting diode (LED) module 140.

Furthermore, the water tank 110 is disposed with the water pump 111 for pumping out water from the water tank 110; the water tank 110 is configured for the cultivation of aquatic life, therefore the water in the water tank 110 may contain excrement from the cultivated aquatic life.

The drain pan 120 is disposed above the water tank 110 and connected to the water pump 111 in the water tank 110 via the pipe 112. The drain pan 120 is disposed with water outlet 121 and a plurality of water dispensing openings 122; preferably, the water outlet 121 is disposed at the center of the drain pan 120, an end of the pipe 112 is connected to the water outlet 121 while the other end thereof is connected to the water pump 111, so the water inside the water tank 110 can be pumped out by the water pump 111 through the water outlet 121. Preferably, the water outlet 121 is disposed at a position above the water dispensing openings 122.

The at least one hydroponic module 130 is disposed between the water tank 110 and the drain pan 120. The hydroponic module 130 includes a plurality of pot bodies 131, each pot body 131 of the hydroponic module 130 that is connected to the drain pan 120 respectively corresponds to each water dispensing opening 122, such that each water dispensing opening 122 is able to dispense water to the corresponding pot body 131. Every pot body 131 includes an inner pot 132 and an outer pot 133, the inner pot 132 is disposed in the outer pot 133; the inner pot 132 and the outer pot 133 are separated by a distance whereas a plurality of draining hole 134 are disposed on the bottom of the inner pot 132. The overflow outlet 135 is disposed near the opening on top of the outer pot 133 while the draining channel 136 connected to the overflow outlet 135 is disposed on the outer side of the outer pot 133; the draining channel 136 is configured such that the liquid in the draining channel 136 flows towards the water tank 110.

The LED module 140 is disposed above the hydroponic module 130 so as to provide the hydroponic plants growing in the hydroponic module 130 with light energy for photosynthesis.

Refer to the Table 1 and Table 2 respectively representing the heights of the lettuce seedlings and the Japanese mustard spinach seedlings measured after being illuminated for 7 days.

TABLE 1

| Lettuce | Red and Blue Light 3:1 | White Light |
|---|---|---|
| 1^{st} Pot | 6.5 cm | 1.5 cm |
| 2^{nd} Pot | 6.0 cm | 3.0 cm |
| 3^{rd} Pot | 7.0 cm | 4.2 cm |
| 4^{th} Pot | 6.5 cm | 3.0 cm |
| Average | 6.5 cm | 2.9 cm |

TABLE 2

| Lettuce | Red and Blue Light 3:1 | White Light |
|---|---|---|
| 1^{st} Pot | 1.5 cm | 0.8 cm |
| 2^{nd} Pot | 2.0 cm | 1.4 cm |
| 3^{rd} Pot | 2.5 cm | 2.0 cm |
| 4^{th} Pot | 2.0 cm | 1.5 cm |
| Average | 2.0 cm | 1.4 cm |

The tables apparently indicates that the LED module 140 of the present invention configured to project red and blue light with ratio of 3:1, i.e. the LED module 140 formed from 3 red LED and 1 blue LED of the present invention is capable of significantly promoting the growth rate of the hydroponic plant seedlings. However, the aforementioned exemplary embodiment is solely for illustrative purpose, as the duration and the timing of illumination depends on the species of the plants, therefore the present invention is not limited thereto.

Furthermore, the hydroponic device 100 of the present invention is configured to fetch water from the water tank 110 via the water pump 111, whereby the water will be delivered to the drain pan 120 through the pipe 112, and then be dispensed to the pot bodies 131 through the corresponding water dispensing openings 122 of the drain pan 120. Subsequently, the water inside the inner pots 132 of the pot bodies 131 will flow to the corresponding outer pots 133 accommodating the inner pots 132 through the plurality of draining holes 134. When the water level in any outer pot 133 is higher than the overflow outlet 135, the water will flow out of the corresponding overflow outlet 135 and flow through the draining channel 136, then re-enter the water tank 110. With the water circulation mechanism of the present invention, water can be circulated in the system continuously and the ammonia concentration in water can be reduced through the oxidation process performed by nitrifying bacteria such as the Nitrosomonas and Nitrobacter in the pot bodies 131; in addition the nitrifying bacteria converts the ammonia into nitrates which may serve as the nutrients for the hydroponic plants.

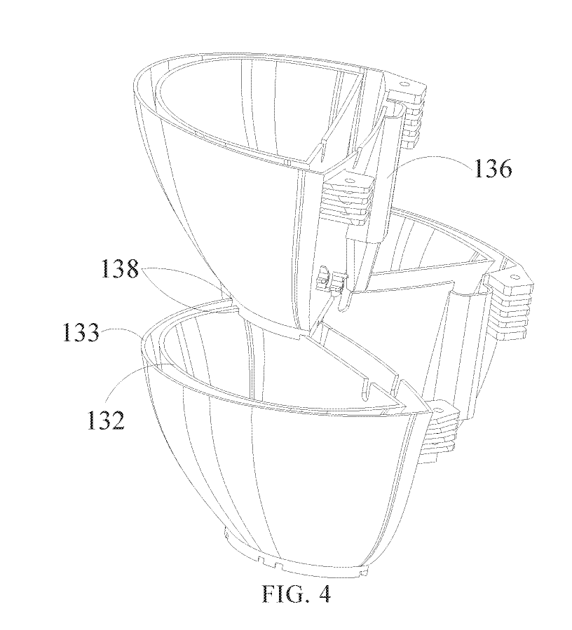

FIG. 4 is the schematic diagram illustrating part of the hydroponic module of the hydroponic device of the present invention. As shown in the figure, when there are a plurality of hydroponic modules 130, the hydroponic modules 130 may be configured to overlap with each other in a manner shown in the FIG. 1. The uppermost hydroponic module 130 may be connected to the draining pan 120, whereas the lowermost hydroponic module 130 may be connected to the water tank 110. With the configuration, each pot body 131 of the uppermost hydroponic module 130 is able to fetch water from the corresponding water dispensing opening 122, then the draining channel 136 of the outer pot 133 of each pot body 131 discharges water to each corresponding pot body 131 of the next hydroponic module 130 under the uppermost hydroponic module 130 and so on, such that water is sequentially discharged to the lowermost hydroponic module 130, then the draining channel 136 of the lowermost hydroponic module 130 discharges the water to the water tank 110.

Referring to FIG. 1 again, in order to ensure that the light emitted from the LED module 140 is able to reach each pot body 131 in the overlapping hydroponic modules 130 without being blocked by upper pot bodies 131, the pot bodies 131 in every hydroponic module 130 and the pot bodies 131 in the adjacent hydroponic module 130 are arranged in a staggered manner. Besides, each pot body 131 may be connected to a LED module 140; more precisely, the LED module 140 may be disposed with a stick, one end of the stick is connected to the LED panel above the pot body 131 while the other end is connected to the exterior surface of the pot body 131.

Referring to FIG. 4, the bottom of each pot body 131 may be disposed with two coupling parts 138. Each pot body 131 is connected to the rim of the inner pot 132 and the rim of the outer pot 133 of the lower pot body 131 via both of the coupling parts 138, so as to strengthen the coupling between each overlapping hydroponic module 130.

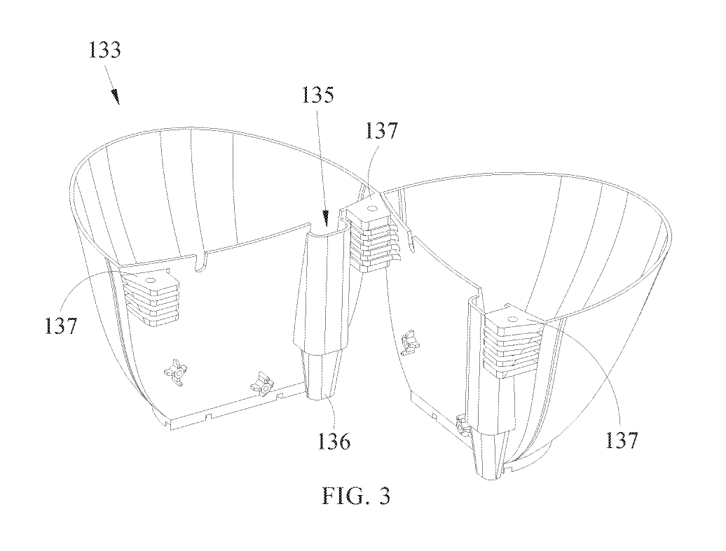

Referring to FIG. 3, two connecting parts 137 may be respectively disposed at two sides near the opening of each pot body 131; each pot body 131 is interconnected with the pot bodies 131 at both sides via both of the connecting parts 137. Furthermore, each connection between the connecting parts 137 of the interconnected pot bodies 131 may be reinforce with a connecting element.

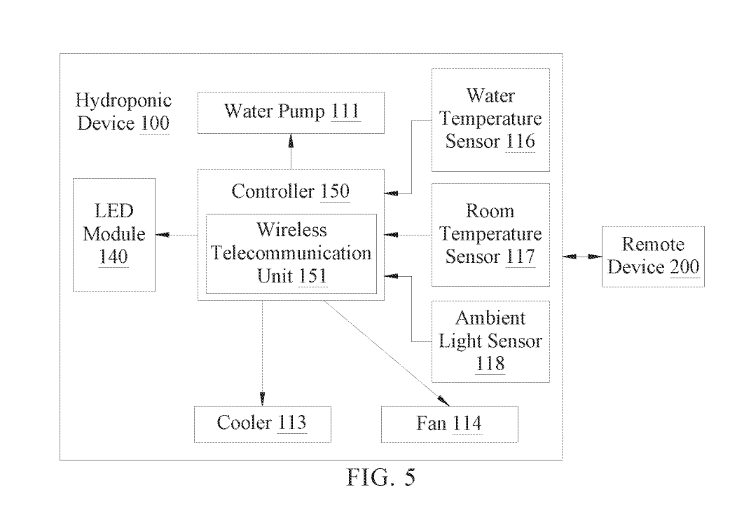

FIG. 5 is the block diagram illustrating the hydroponic device of the present invention. As can be appreciated in the figure, the hydroponic device 100 may be further disposed with a controller 150 capable of transmitting control signal to the water pump 111 and the at least one LED module 140 to control the operation of the water pump 111 and the LED module 140.

Furthermore, the water tank 110 may be disposed with a cooler 113 or a fan 114. In addition, the controller 150 may be connected to a water temperature sensor 116, the controller 150 generates the control signal for the cooler 113 or the fan 114 according to the water temperature information sensed by the water temperature sensor 116. For instance, when the water temperature information indicates that the water temperature is too high, the controller 150 is configured to activate the cooler 113 or the fan 114 by transmitting the control signal thereto, so that the cooler 113 or fan 114 is able to lower the water temperature.

In addition, the controller 150 may be connected to the room temperature sensor 117 to receive the room temperature information sensed by the room temperature sensor 117. It is noteworthy that the controller 150 may be connected to a display module so that the controller 150 is able to generate the control signal for the display module to display the room temperature according to the room temperature information.

Besides, the controller 150 may be connected to an ambient light sensor 118. The controller 150 is configured to generate the control signal for the at least one LED module 140 according to the brightness information sensed by the ambient light sensor 118.

Apart from that, the controller 150 may include a wireless telecommunication unit 151 to connect to a remote device 200. The remote device 200 is configured to transmit the instruction signal to the controller 150 so the controller 150 is able to generate the control signal accordingly, such that the activation/deactivation of the LED module 140, water pump 111, cooler 113 or fan 114 can be controlled remotely. Besides, the controller 150 may be configured to transmit the water temperature information, room temperature information or the brightness information to the remote device 200, such that the remote device 200 is able to remotely monitor the status of the hydroponic device 100. In an actual embodiment, the remote device 200 may be an electronic device e.g. a smartphone, tablet, laptop or desktop.

In conclusion, the hydroponic device of the present invention is able to pump the water with excrements of aquatic life to each pot body, and then the nitrifying bacteria such as the Nitrosomonas and Nitrobacter in the pot body purify the water by converting the ammonia into nitrates, such that the present invention is capable of purifying water for the aquatic life as well as supplying nutrients for the hydroponic plants. Besides, the LED module of the present invention is able to enhance the growth rate of the hydroponic plants by supplying the hydroponic plants with light for photosynthesis.

The descriptions hereinbefore are merely illustrative instead of restrictive. It is understood that various modifications could be applied to the disclosure without deviating from the scope and spirit of the invention that is set forth in the appended claims.

What is claimed is:

1. A hydroponic device, comprising:
a water tank disposed with a water pump;
a drain pan disposed above the water tank and disposed with a water outlet and a plurality of water dispensing openings, wherein one end of a pipe is connected to the water outlet while the other end is connected to the water pump;
at least one hydroponic module disposed between the water tank and the drain pan, the at least one hydroponic module comprising a plurality of pot bodies, wherein each of the pot bodies respectively corresponds to each of the water dispensing openings and comprises an inner pot and an outer pot, the inner pot having a plurality of draining holes on a bottom thereof is disposed in the outer pot, the outer pot is disposed with an overflow outlet near an opening of the outer pot, a draining channel connected to the overflow outlet is disposed on an outer side of the outer pot; and
at least one light emitting diode (LED) module disposed above the at least one hydroponic module.

2. The hydroponic device of claim 1, wherein when there are a plurality of the hydroponic modules, the plurality of hydroponic modules overlap with each other, an uppermost hydroponic module is connected to the drain pan while an lowermost hydroponic module is connected to the water tank.

3. The hydroponic device of claim 2, wherein the plurality of pot bodies of each hydroponic module and the plurality of pot bodies of an adjacent hydroponic module are arranged in staggered manner.

4. The hydroponic device of claim 2, wherein two coupling parts are disposed at a bottom of each pot body; the pot body is coupled to a rim of the inner pot and a rim of the outer pot of a lower pot body via the two coupling parts.

5. The hydroponic device of claim 1, wherein a connecting part is respectively disposed at both sides near an opening of each pot body, each pot body is interconnected with the pot bodies at both sides via both of the connecting parts.

6. The hydroponic device of claim 1, further comprising a controller disposed on the hydroponic device, wherein the controller transmits a control signal to the water pump and the at least one LED module.

7. The hydroponic device of claim 6, wherein the water tank comprises a cooler and the controller is connected to a water temperature sensor, the controller generates the control signal for the cooler according to water temperature information sensed by the water temperature sensor.

8. The hydroponic device of claim 6, wherein the controller is connected to a room temperature sensor and receives room temperature information sensed by the room temperature sensor.

9. The hydroponic device of claim 6, wherein the controller is connected to an ambient light sensor, the controller generates the control signal for the at least one light emitting diode according to brightness information sensed by the ambient light sensor.

10. The hydroponic device of claim 6, wherein the controller comprises a wireless telecommunication unit serving as connection between a remote device and the controller; the remote device transmits an instruction signal to the controller and the controller generates the control signal according to the instruction signal.
